(19) United States
(12) Patent Application Publication
(10) Pub. No.: US 2026/0310870 A1
(43) Pub. Date: Oct. 8, 2026

(54) METHODS AND APPARATUS FOR IMPROVING CHIP DESIGN WITH DESIGN TECHNOLOGY CO-OPTIMIZATION USING ARTIFICIAL INTELLIGENCE AND MACHINE LEARNING

(71) Applicant: Samsung Electronics Co., Ltd., Gyeonggi-do (KR)

(72) Inventors: Duo DING, Austin, TX (US); Saurabh JAIN, Bee Caves, TX (US); Matthew STREYLE, Austin, TX (US); Kunhyuk KANG, San Diego, CA (US)

(21) Appl. No.: 19/347,375

(22) Filed: Oct. 1, 2025

Related U.S. Application Data
(60) Provisional application No. 63/783,932, filed on Apr. 4, 2025.

(51) Int. Cl. G06F 30/337; G06F 30/27; G06F 119/06

(52) U.S. Cl. CPC G06F 30/337; G06F 30/27; G06F 2119/06

(57) ABSTRACT

A system and method are disclosed for improving power/performance/area (PPA) of a semiconductor chip design, the method comprising: refining a set of PPA features of the semiconductor chip design; reducing a dimensionality of the set of PPA features by applying a variational autoencoder (VAE) or clustering; selecting, for a respective design block within the semiconductor chip design, a respective highly ranked design element from a library of technology design elements based on the reduced dimensionality; and applying the respective highly ranked design element to the respective design block to improve PPA of a semiconductor chip having the semiconductor chip design.

### CROSS-REFERENCE TO RELATED APPLICATION

This application claims the priority benefit under 35 U.S.C. § 119(e) of U.S. Provisional Application No. 63/783,932, filed on Apr. 4, 2025, the disclosure of which is incorporated by reference in its entirety as if fully set forth herein.

### TECHNICAL FIELD

The disclosure generally relates to power/performance/area (PPA) of a semiconductor chip design. More particularly, the subject matter disclosed herein relates to improved systems and methods for optimization of PPA of a semiconductor chip design as a whole.

### SUMMARY

Improving semiconductor chip power/performance/area (PPA) in leading-edge semiconductor technology can be very challenging. The problem of design choice proliferation can constrain design flow. For example, the high dimensionality of PPA feature space (e.g., the space of design recipe variations that may be explored via design technology co-optimization (DTCO) and chip design data) can drive bottlenecks in optimization algorithms. While semiconductor chip PPA improvements may be made using off-the-shelf vendor tools or flows as well as manual fine-tuning, and some user-defined automation scripts, each of these methods faces challenges.

Off-the-shelf vendor tools or flows may have limited PPA improvement differentiations and may provide diminishing returns for graphics processing units (GPUs) after a number of iterations due to the heterogenous nature of GPU clusters, cores, and/or tiles. Manual fine-tuning by individual domain experts may have limited efficiency in operations and may be highly empirical. Some user defined automation and special purpose tools may scale poorly due to the high dimensionality of the technology parameters and design options, and thus may face tradeoffs between accuracy and runtime or computing resources.

To overcome these issues, systems and methods are described herein for identifying recipes to improve PPA efficiently and uniquely for individual blocks/clusters/tiles, as well as design flow to enable the discovered PPA recipes hierarchically and successively during chip implementation steps. For example, the system can execute recipe-driven improvements in a reduced latent space for computing efficiency. The system can provide feature engineering for PPA features, dimensionality reduction of the PPA features, and in-latent-space computing. In addition, the system can handle multiple interlocked chip PPA objectives, such as area, timing, leakage (e.g., design elements that are suboptimal in power), dynamic power, and ratios between each objective. Finally, the disclosed embodiments can provide hierarchical recipe applications, such as design methodology to hierarchically train and deploy artificial intelligence (AI) models to optimize PPA uniquely per sub-cluster, thereby optimizing the chip design as a whole.

In an embodiment, a method of improving PPA of a semiconductor chip design comprises refining a set of PPA features of the semiconductor chip design; reducing a dimensionality of the set of PPA features by applying a variational autoencoder (VAE) or clustering; selecting, for a respective design block within the semiconductor chip design, a respective highly ranked design element from a library of technology library design elements, based on the reduced dimensionality; applying the respective highly ranked design element to the respective design block within the semiconductor chip design to obtain an updated semiconductor chip design with improved PPA; and outputting the updated semiconductor chip design for a semiconductor chip with improved PPA.

In an embodiment, a computer system configured to improve PPA of a semiconductor chip design comprises: at least one processor; and memory that stores instructions, which when executed by the at least one processor, control the computer system to: refine a set of PPA features of the semiconductor chip design; reduce a dimensionality of the set of PPA features by applying a variational autoencoder (VAE) or clustering; select, for a respective design block within the semiconductor chip design, a respective highly ranked design element from a library of technology library design elements, based on the reduced dimensionality; apply the respective highly ranked design element to the respective design block within the semiconductor chip design to obtain an updated semiconductor chip design with improved PPA; and outputting the updated semiconductor chip design for a semiconductor chip with improved PPA.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a system for improving power/performance/area (PPA) of a semiconductor chip design, according to an embodiment.

FIG. 2 is a network architecture diagram showing a variational autoencoder (VAE) for dimensional reduction of PPA features, according to an embodiment.

FIG. 3 illustrates clustering of PPA features in a latent space of reduced dimensionality, according to an embodiment.

FIG. 4 illustrates iterative PPA improvement in a histogram of design elements resulting from a hierarchical model flow, according to an embodiment.

FIG. 5 is a flow diagram illustrating a method of improving PPA of a semiconductor chip design, according to an embodiment.

FIG. 6 is a flow diagram illustrating a method of iterative dimension reduction for insights derivation, according to an embodiment.

FIG. 7 is a flow diagram illustrating a method of outlier insights derivation, according to an embodiment.

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Improving semiconductor chip power/performance/area (PPA) in leading-edge semiconductor technology can be very challenging. The problem of design choice proliferation can constrain design flow. For example, the high dimensionality of PPA feature space (e.g., the space of design recipe variations that may be explored via design technology co-optimization (DTCO) and chip design data) can drive bottlenecks in optimization algorithms. Semiconductor chip PPA improvements are often made using off-the-shelf vendor tools or flows as well as manual fine-tuning, and some user-defined automation scripts. However, each of these methods faces challenges.

Off-the-shelf vendor tools or flows may have limited PPA improvement differentiations. Moreover, they may provide diminishing returns for graphics processing units (GPUs) after a number of iterations, due to the heterogenous nature of GPU clusters, cores, and/or tiles. Likewise, vendor algorithms may be designed to perform towards an “average best” among standardized industry benchmarks (e.g., designed for CPUs and SOCs).

Manual fine-tuning by individual domain experts may have limited efficiency in operations and may be highly empirical. In particular, deeply interlocked sub-domains may require significant expertise and ingenuity to achieve meaningful improvements. In some cases, such approaches may be prone to inertia against further optimization after a satisficing solution is found. Moreover, these approaches may face poor cross-knowledge domain transferability.

User defined automation and special purpose tools may include black box-driven methods (e.g., Bayesian, decision trees, and reinforcement learning), which may scale poorly due to the high dimensionality of the technology parameters and design options. As a result, methods based on user defined automation and special purpose tools may face tradeoffs between accuracy and runtime or computing resources.

The disclosed system and methods can address these challenges by providing procedures to identify recipes to improve PPA efficiently and uniquely for individual blocks/clusters/tiles, and novel design flow to enable the discovered PPA recipes hierarchically (e.g., according to a hierarchical PPA recipe flow) and successively during chip implementation steps. For example, embodiments can execute the recipe-driven improvements in a reduced latent space for computing efficiency, and validate artificial intelligence / machine learning (AI/ML) quality of results (QoR) with the hierarchical PPA chip building flow. A system and methods according to embodiments can provide feature engineering, such as by defining and refining the importance of PPA features by big data engineering and iterative improvements of key performance indicators (KPI) scores. In addition, the disclosed system and methods can provide dimensionality reduction and in-latent-space computing. In particular, they can reduce DTCO parameter space dimensions, implement methods to categorize and discover PPA recipes within the latent space dimension, and handle multiple interlocked chip PPA objectives, such as area, timing, leakage (e.g., design elements that are suboptimal in power), dynamic power, and ratios between each objective. Finally, the disclosed embodiments can provide hierarchical recipe applications, such as design methodology to hierarchically train and deploy AI models to optimize PPA uniquely per sub-cluster.

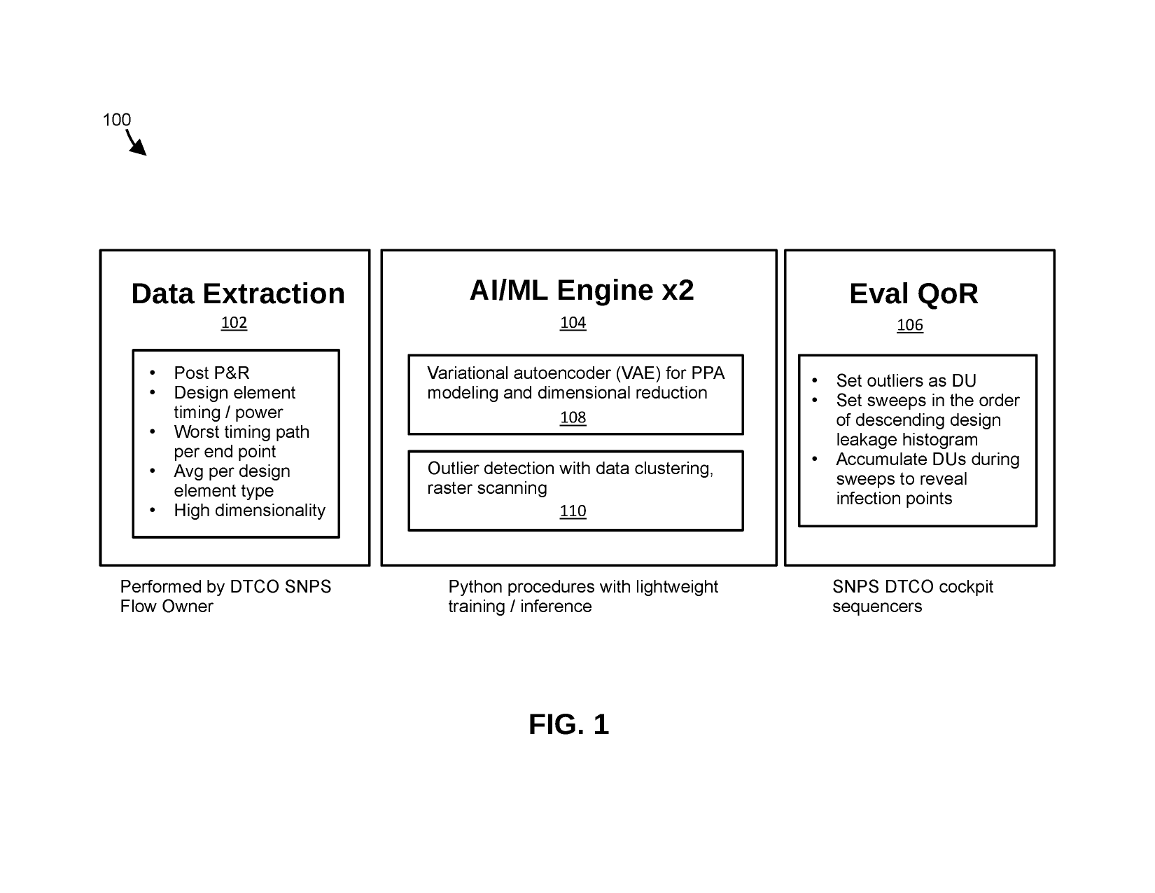

FIG. 1 is a block diagram illustrating a system 100 for improving PPA of a semiconductor chip design, according to an embodiment.

Referring to FIG. 1, the system 100 can include data extraction 102, a two-part AI/ML engine 104, and a QoR evaluator 106.

The data extraction 102 can define and refine key contributing factors for chip PPA KPI scores based on production big data. Data extraction 102 may include defining and/or refining features such as stages in the design flow (floor-planning, power planning, placement, clock-tree synthesis, routing, and the like), design element timing and/or power, worst timing path per end point, average per design element type, and high dimensionality. According to embodiments, the data extraction 102 may involve feature engineering, such as defining and refining the importance of PPA features by big data engineering and iterative improvements of KPI scores. In some examples, the data extraction 102 may be performed at block level, cluster level or full chip level.

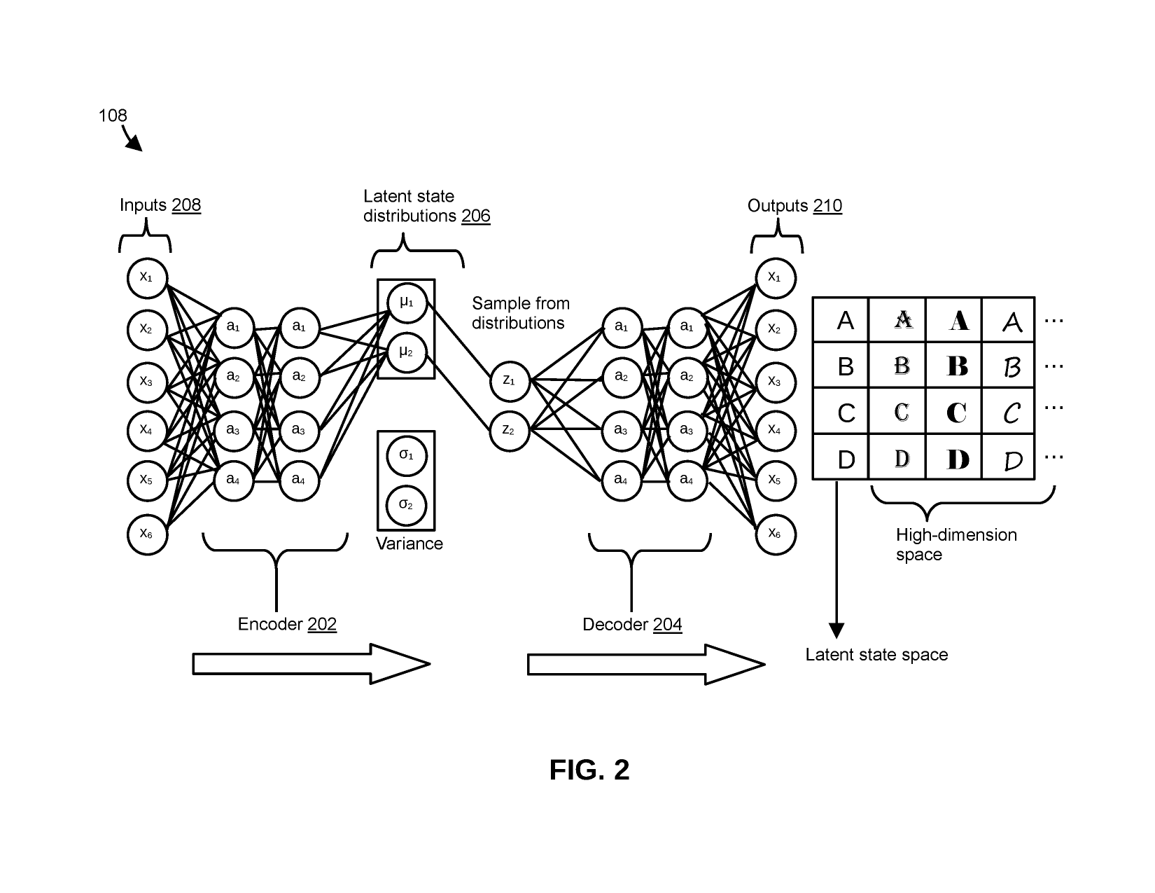

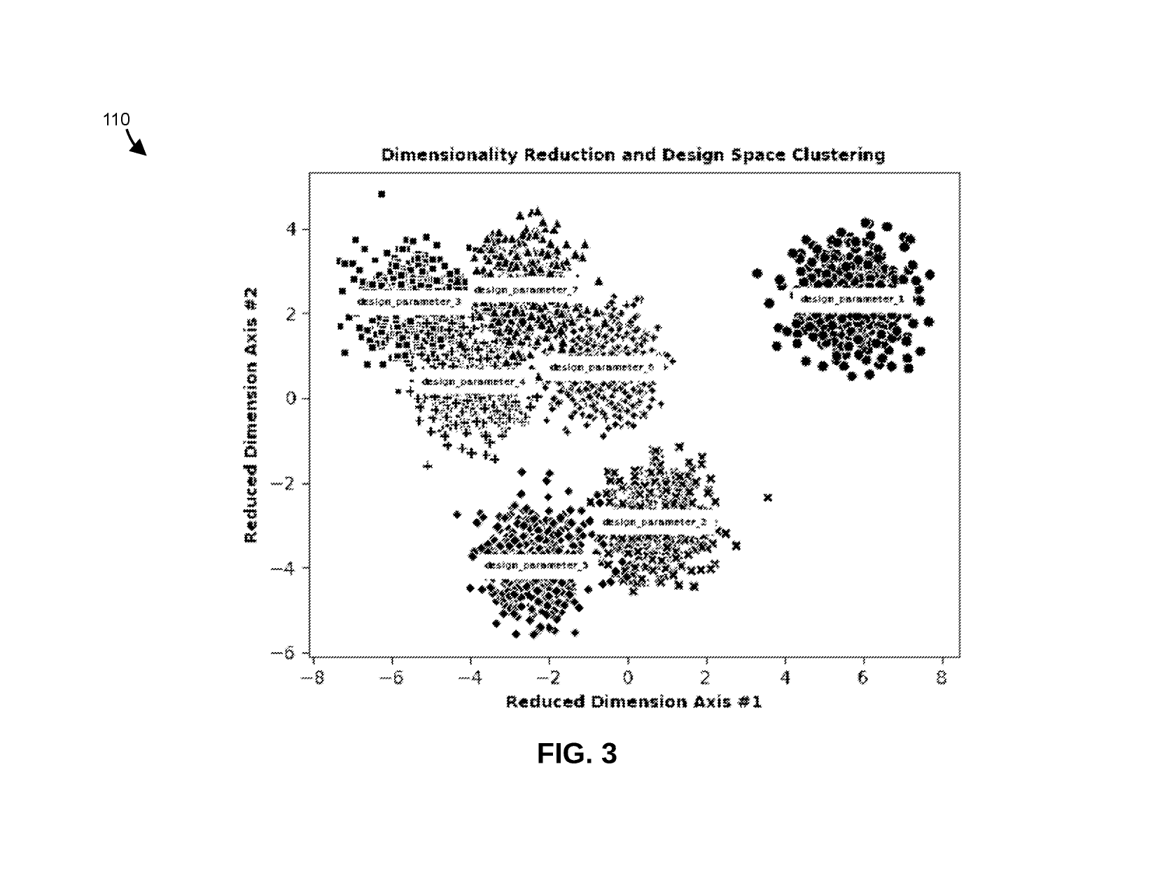

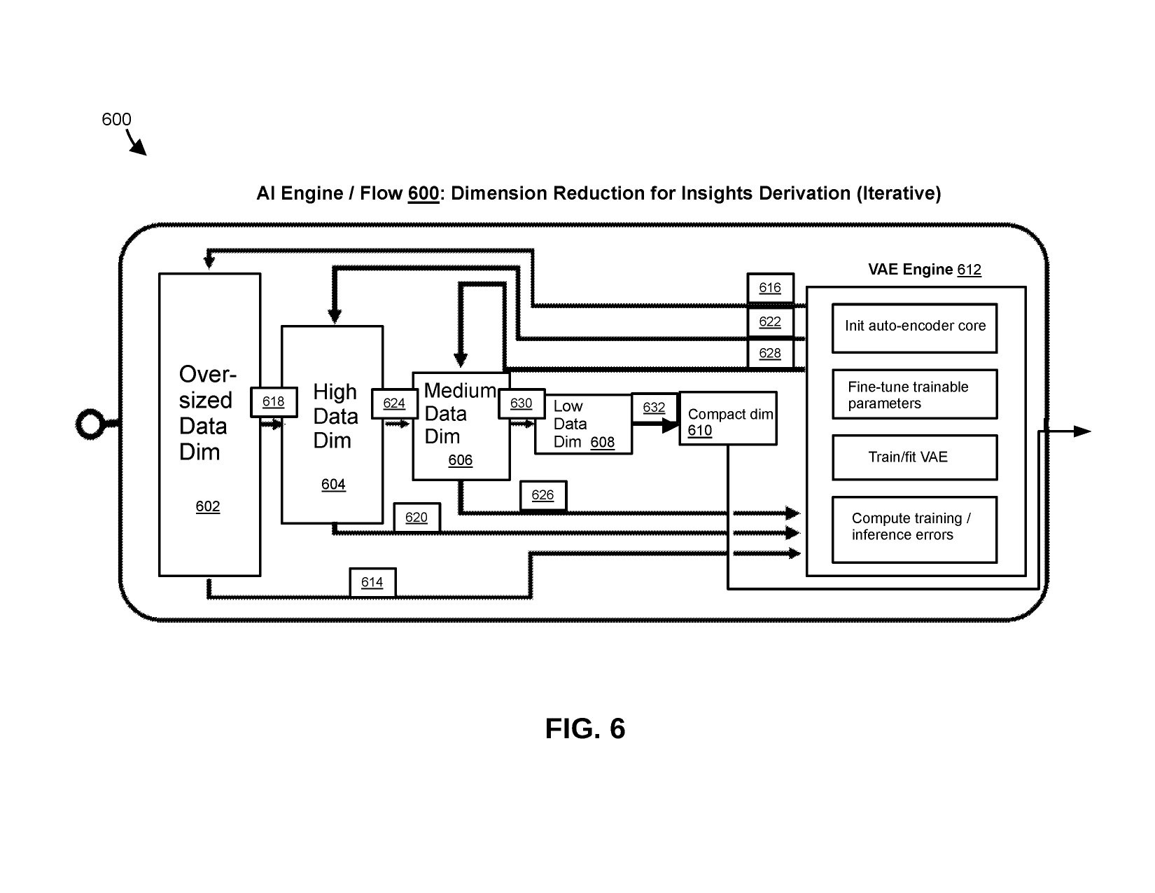

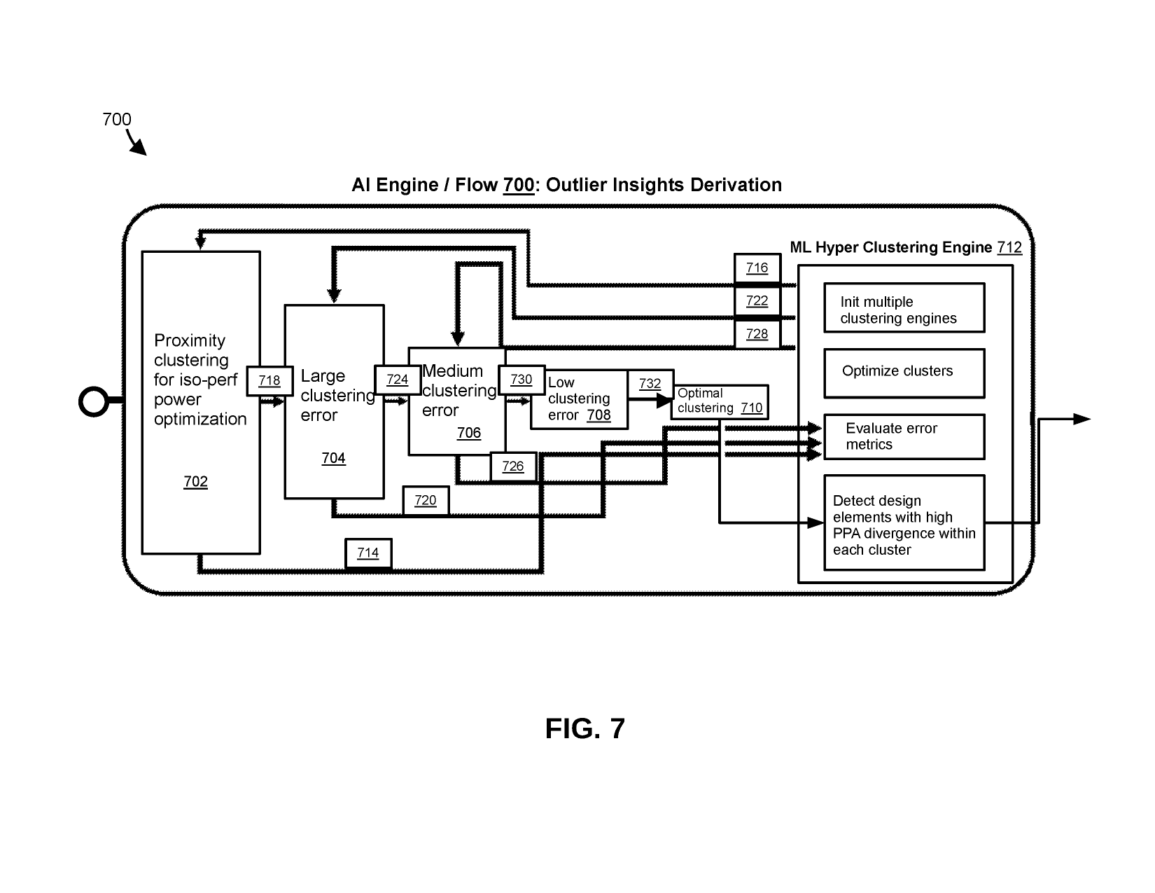

In various examples, the two-part AI/ML engine 104 can reduce the dimensionality of the DTCO parameter space, implement methods to categorize and discover PPA recipes within the latent space dimension, and handle multiple interlocked chip PPA objectives, such as area, timing, leakage, dynamic power, and ratios between each objective. The two-part AI/ML engine 104 (e.g., a generative AI engine) can include a variational autoencoder (VAE) 108 and outlier detection 110 (e.g., an ML engine). The VAE 108 can generate a latent space with reduced dimension based on the original PPA feature space (e.g., DTCO parameter space). The VAE 108 can include an encoder and decoder, and can perform PPA modeling, dimensional reduction, and in-latent-space computing, as described in greater detail in the example of FIGS. 2 and 6 below. For example, the latent space may be a space of reduced dimensionality, which can be encoded (e.g., compressed) by the encoder and decoded by the decoder of VAE 108. Accordingly, the VAE 108 can optimize, such that the outputs of the decoder of VAE 108 predict the inputs of the encoder of VAE 108 as accurately as possible. The outlier detection 110 can perform data clustering (e.g., based on ML clustering or another clustering algorithm) and raster scanning, as described in the examples of FIGS. 3 and 7 below. The outlier detection 110 may classify outliers in the reduced dimensions, based on combinations of multiple PPA KPI scores, into categories of performance, power leakage, or area outliers.

The dimensional reduction performed by AI/ML engine 104, VAE 108, and/or outlier detection 110 may greatly simplify the problem of optimizing the PPA of individual design elements, design blocks, and/or the semiconductor chip design as a whole. For example, the system may execute core optimization algorithms in the resulting reduced dimensions (e.g., latent space algorithms) to efficiently identify best (e.g., highly ranked or highest ranked) PPA recipes. Accordingly, by executing within the reduced dimensions, the system can improve the computational efficiency of such core methods by orders of magnitude, with minimal loss of accuracy.

In some examples, the AI/ML engine 104 may be implemented via Python procedures with lightweight training and inference.

The QoR evaluator 106 can set outliers as disabled design elements (DU), set sweeps in the order of descending design leakage histogram, and accumulate DUs during sweeps to reveal the inflection point. For example, the QoR evaluator 106 can disable (e.g., prune or discard) the outliers in the design recipe and re-evaluate chip performance.

In some examples, the AI/ML engine 104 and/or the QoR evaluator 106 can implement a hierarchical AI model to perform a multi-objective optimization of the PPA of a given semiconductor chip design. For example, the AI model may include one or more ML method such as clustering, classification, regression, decision trees, deep learning neural networks or reinforcement learning, etc. The multi-objective optimization can include selecting a best (e.g., highly ranked or highest ranked) technology library design element for each respective design block. For example, the AI/ML engine 104 may take advantage of the reduced dimensionality (e.g., the latent space) and the hierarchical AI model to identify one or more PPA design recipe for the semiconductor chip design, which may include the respective best technology design element for the respective design block. The respective best technology design element may be selected from a library of technology design elements.

Subsequent to the dimensional reduction, clustering, outlier detection, and/or PPA design recipe identification performed by the AI/ML engine 104, the QoR evaluator 106 may participate in the multi-objective optimization of the semiconductor chip design’s PPA. For example, QoR evaluator 106 evaluate the PPA (e.g., the QoR) of the semiconductor chip design as a whole, which may include heterogeneous tiles such as GPUs, CPUs, cores, SOCs, and the like.

In some embodiments, these optimization functions of the AI/ML engine 104 and QoR evaluator 106 may be iterated, e.g., according to the hierarchical AI model. For example, the AI/ML engine 104 and/or the QoR evaluator 106 can then iteratively use the reduced dimensionality (e.g., the latent space) and the hierarchical AI model to identify a second PPA design recipe, which can include an iterated (e.g., improved) best technology library design element for each respective design block. In an embodiment, this iterative optimization can be guided by the hierarchical AI model, accordingly capturing second-order effects. As part of the multi-objective optimization of PPA, the system can then apply the iterated best technology library design element to the respective design blocks.

The disclosed system can utilize a large volume of chip design data to derive key metrics and insights and visualize impacts of these insights. The system can thereby enable seamless optimization between process technologies and chip design, and can achieve both superior efficiency and accuracy, with practically no trade-off between them. In various examples, the QoR evaluator 106 may be implemented as a standalone chip design flow, or as an incremental modification to an already implemented chip with respect to logic and physical design contents.

FIG. 2 is a network architecture diagram showing the VAE 108 for dimensional reduction of PPA features, according to an embodiment.

Referring to FIG. 2, the VAE 108 can include an encoder 202 and decoder 204, and can perform PPA modeling, dimensional reduction, and in-latent-space computing, as described herein. For example, the latent space 206 may be a space of reduced dimensionality, which can be encoded (e.g., compressed) by the encoder 202 and decoded by the decoder 204. The VAE 108 can thus optimize, such that the outputs 210 of the decoder 204 predict the inputs 208 of the encoder 202 as accurately as possible. Accordingly, the VAE 108 can construct a latent space 206 of reduced dimensionality based on the original parameter space of PPA features 208. The latent space 206 can have a Euclidean distance measure, wherein cells or design elements can be separated by Euclidean distance representing (e.g., a decreasing function of) their similarity.

As a result of the dimensional reduction, there can be a manageable number of training parameters (e.g., hundreds to thousands of parameters). The dimensional reduction performed by VAE 108, and/or the clustering (e.g., described in the example of FIG. 3 below) may greatly simplify the problem of optimizing the PPA of individual design elements, design blocks, and/or the semiconductor chip design as a whole. For example, the system may execute core optimization algorithms in the resulting reduced dimensions 206 (e.g., latent space algorithms) to efficiently identify best (e.g., highly ranked or highest ranked) PPA recipes. Accordingly, by operating within the reduced dimensions, the system can improve the computational efficiency of such core methods by orders of magnitude, with minimal loss of accuracy.

FIG. 3 illustrates clustering 110 of PPA features in a latent space of reduced dimensionality, according to an embodiment. Referring to FIG. 3, the illustrated design elements are plotted in a two-dimensional latent space of PPA features (e.g., with a first feature along Reduced Dimension Axis #1 and a second feature along Reduced Dimension Axis #2). As shown, the plotted design elements are clustered into several clusters of similar elements.

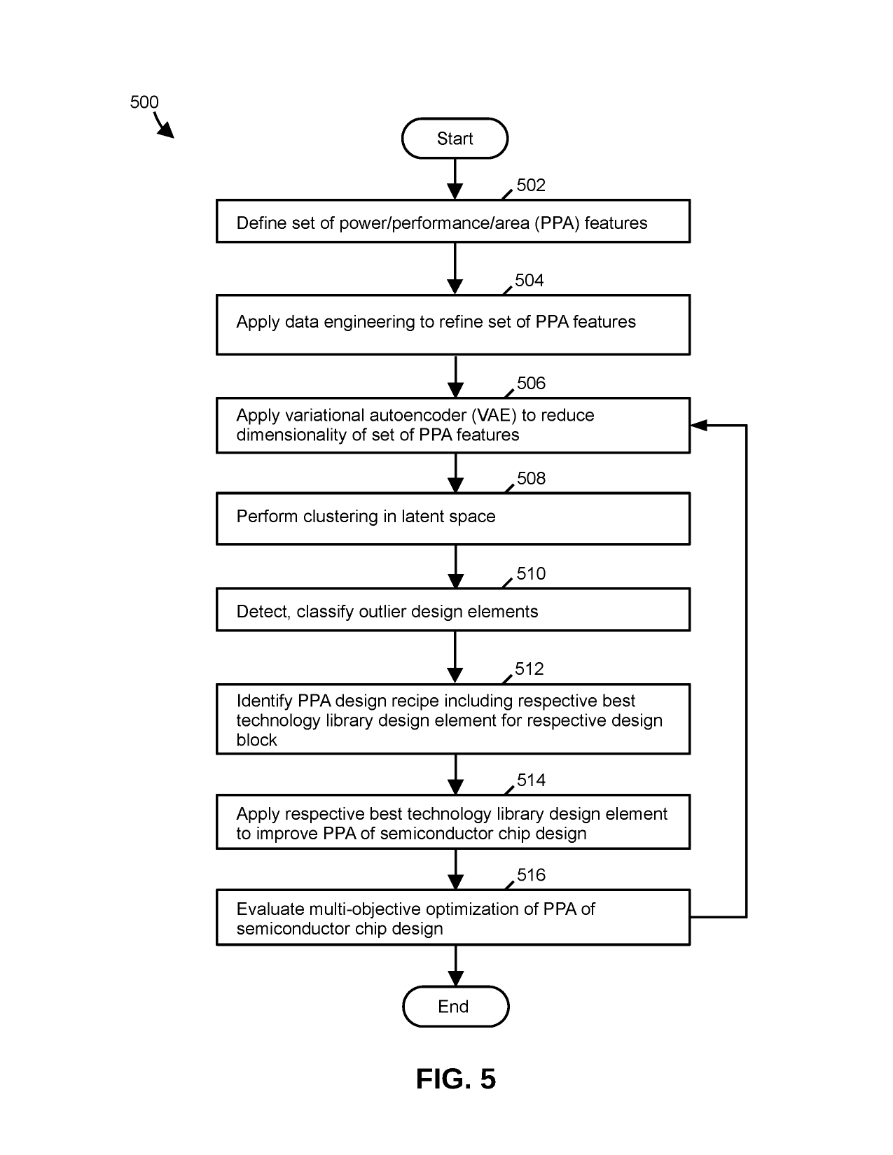

In various embodiments, the system may use ML clustering, t-Distributed Stochastic Neighbor Embedding (tSNE), or another clustering algorithm to perform clustering. In some examples, clustering may emerge from the dimensional reduction performed by VAE 108. For example, VAE 108 may use multivariate Gaussian (e.g., normal distribution) models as clusters, VAE 108 may control loss or cost functions so as to perform clustering during dimensional reduction, and/or the dimensional reduction may result in a latent space wherein cells or other design elements are separated by a Euclidean distance representing their similarity. In some examples, the clustering can be performed iteratively, as described in the example of FIG. 7 below. In some examples, the dimensional reduction, clustering, outlier detection and classification, PPA design recipe identification, design recipe application, and optimization may all be iterated, for example in an interleaved fashion, as described in the example of FIG. 5 below.

In some examples, in the latent space, the PPA features may have normal (e.g., Gaussian) distributions. The outliers may be detected based on this latent space distribution, and/or based on the clustering. In some examples, the system may identify the cells or other design elements furthest from the center of each cluster, and/or cells or design elements to which the identification to a cluster is difficult, as outliers. In some examples, these outliers may be identified as worst-performing cells or other design elements (e.g., as having the worst PPA performance). For example, the system may prune or discard cells or other design elements starting from the most distant ones from the center of each cluster. The outlier detection can be based on data clustering and raster scanning.

In addition, in some embodiments, the outlier detection may classify outliers in the reduced dimensions, based on combinations of multiple PPA KPI scores, into categories of performance, power leakage, or area outliers.

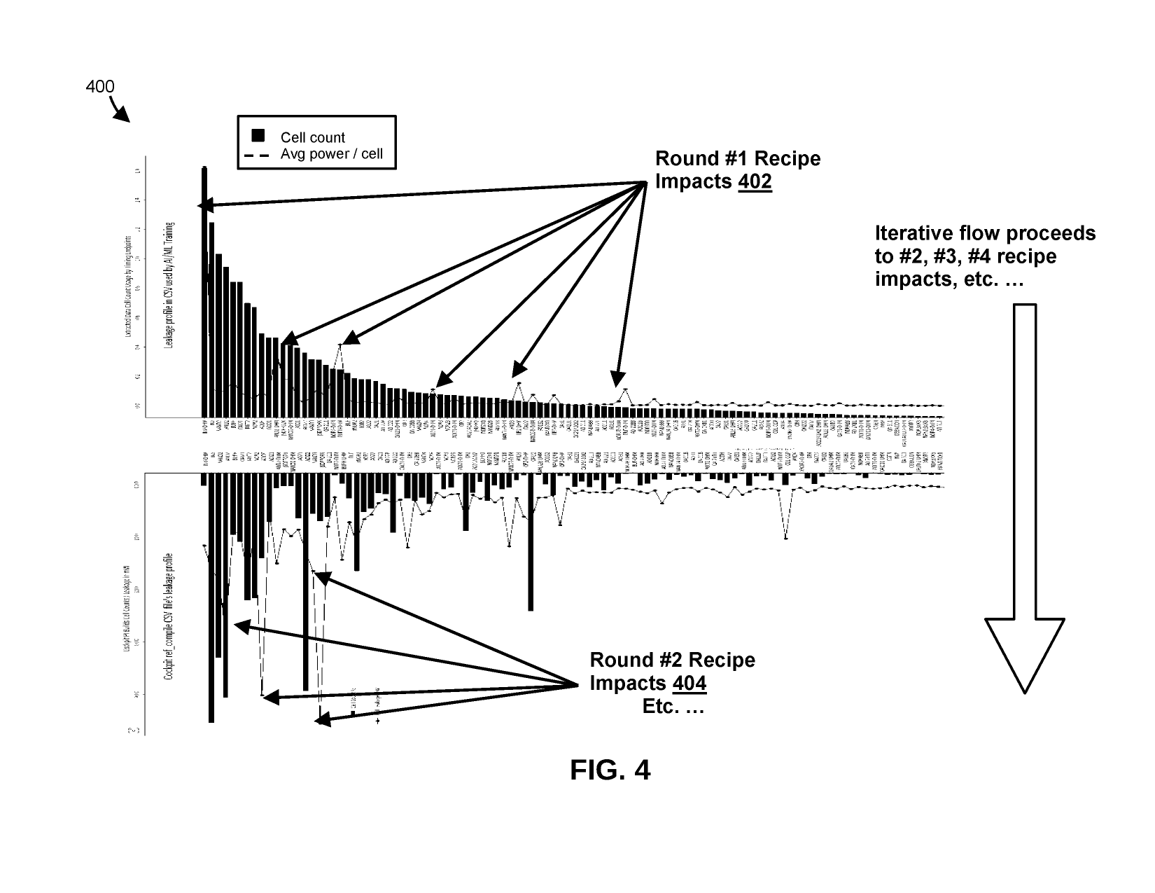

FIG. 4 illustrates iterative PPA improvement in a histogram 400 of design elements resulting from a hierarchical model flow, according to an embodiment.

Referring to FIG. 4, the dashed line with markers represents the average power usage (e.g., dissipation) per cell or other design element, such as interconnect, by type (e.g., design recipe). The solid histogram bars represent the number of cells or design elements being used, by type. Accordingly, the total power usage of the semiconductor chip design is represented by the product of the power per design element (dashed line) and the number of design elements (solid bars), summed over all the design element types.

As disclosed herein, the system can optimize PPA of the semiconductor chip design as a whole iteratively, for example by successively improving on each iteration of the design. As shown in FIG. 4, the histogram 400 can include a first iteration (e.g., round #1) histogram 402. Proceeding downward, histogram 400 also shows a second iteration (e.g., round #2) histogram 404. The iterative flow can proceed (e.g., downward along the figure) through multiple iterations (e.g., rounds #3, 4, etc.) until convergence is achieved. For example, the system may iterate the optimization steps any number of times, such as for a predetermined number of iterations, or until reaching a threshold accuracy level. In the example of FIG. 4, the total power usage of the semiconductor chip design (e.g., the product of the dashed line and solid bars, summed over design element types) can decrease from first iteration histogram 402 to second iteration histogram 404, thereby demonstrating that the system successively reduces tower power usage or improves other PPA characteristics of the chip design.

In the example of FIG. 4, the disclosed system is being used to optimize cluster power, while performing tradeoffs over timing and area. In various examples, the system could also be used to perform tradeoffs to optimize timing or area usage, while performing tradeoffs over the remaining PPA variables.

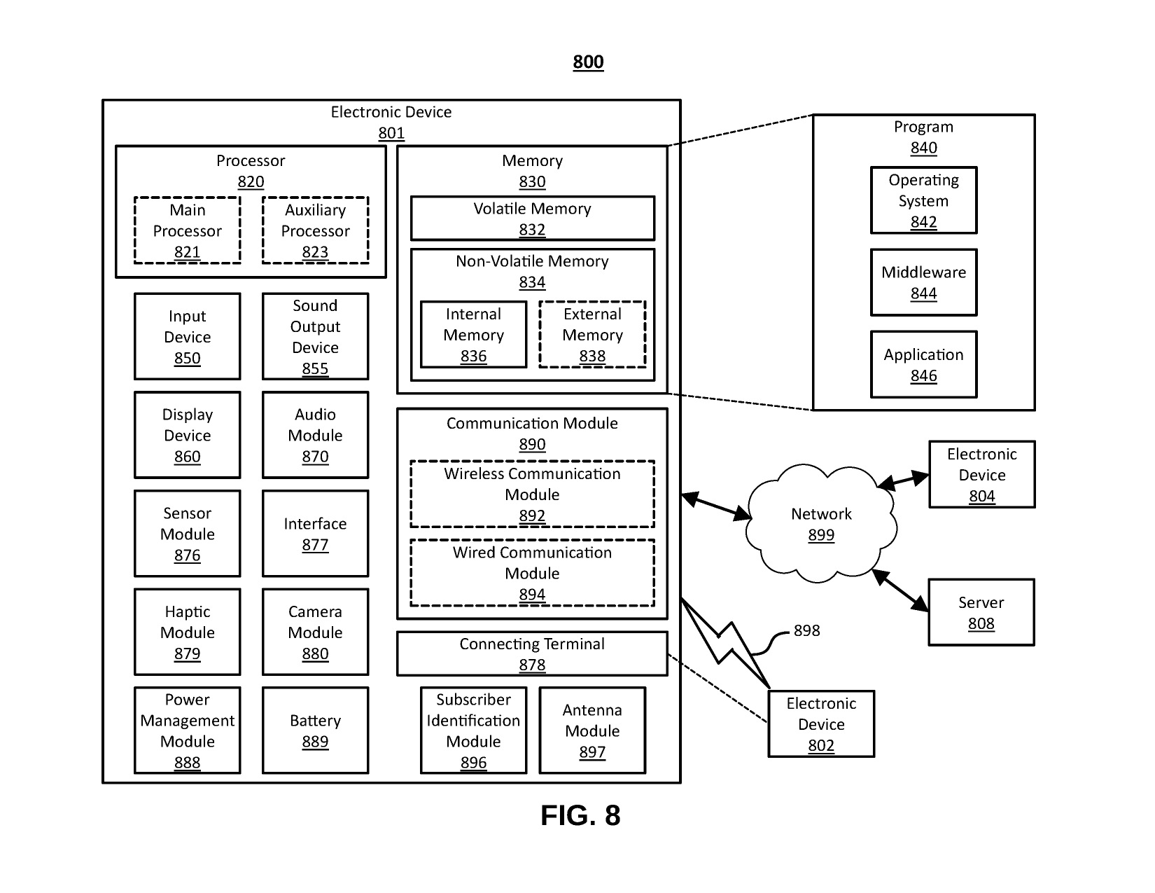

FIG. 5 is a flow diagram illustrating a method 500 of improving PPA of a semiconductor chip design, according to an embodiment. In some examples, the method 500 can be performed by a computer system or other electronic device such as the electronic device 801 of FIG. 8.

Referring to FIG. 5, the method 500 can begin with the system defining at 502 a set of PPA features. For example, the system can define at 502 key metrics as indicators of the PPA per design block. In various examples, the defined metrics may include one or more of: cell delay in time, and extra delays caused by inter-cell cross-talks; input / output transition in time, categorized by rise and fall signals; pin capacitance, to indicate size of down-stream capacitive loads; wire delay, to model interconnect effects that connect cells and blocks by wires and vias, etc. In some examples, the total volume of data may be hundreds of columns by tens of thousands of rows or more.

Next, the system can apply at 504 data engineering to refine the set of PPA features. For example, the system can refine the importance (e.g., significance) of PPA features via big data engineering and via iterative improvements of KPI scores. Applying at 504 data engineering to refine the set of PPA features may include identifying and/or refining features such as stages in the design flow (floor-planning, power planning, placement, clock-tree synthesis, routing, and the like), design element timing and/or power, worst timing path per end point, average per design element type, and high dimensionality.

Next, the system can apply at 506 the VAE to reduce the dimensionality of the set of PPA features, for example by constructing a latent space. As described above, the latent space may be a space of reduced dimensionality, which can be encoded (e.g., compressed) by an encoder and decoded by a decoder of VAE. The VAE can perform PPA modeling, dimensional reduction, and in-latent-space computing.

Next, the system can perform at 508 clustering in the latent space constructed by the VAE at 506. As described above, the system may use tSNE to encode similarities of cell or design element PPA properties in a reduced-dimensional latent space. Accordingly, the system may perform at 508 clustering based on proximity, e.g., based on the property of the latent space that cells or design elements are separated by Euclidean distance representing (e.g., a decreasing function of) their similarity.

Next, the system at 510 can detect and classify outlier design elements. In some examples, detecting and classifying at 510 outlier design elements can also be based on Euclidean distance in the latent space. As illustrated in the example of FIG. 3 above, the system may identify the cells or other design elements furthest from the center of each cluster, and/or ones to which the identification to a cluster is difficult, as outliers. These outliers may be the worst-performing cells or design elements (e.g., with the worst PPA).

Classifying outlier design elements can be based on data clustering and raster scanning. For example, the system may classify outliers in the reduced dimensions, based on combinations of multiple PPA KPI scores, into categories of performance, power leakage, or area outliers.

Next, the system can identify at 512 a PPA design recipe, including a respective best (e.g., highly or highest ranked) technology library design element for a respective design block. For example, the respective best technology library design element may be a design element selected from a library of technology design elements. The design recipe may consist of a strategy for which cells or design elements (e.g., from a technology library) to use in the optimized semiconductor chip design. In some examples, identifying at 512 the respective best technology library design element may be based on a ranking determined by the multi-objective optimization and/or by the hierarchical AI model.

Next, the system can apply at 514 the respective best technology library design element to improve PPA of the semiconductor chip design.

Next, the system can evaluate at 516 the QoR within a multi-objective optimization of the PPA of the semiconductor chip design.

In some examples, the system may visualize impacts of design recipe changes. For example, the system may iteratively apply metric outlier insight flows (AI1 + ML2) on a design database. The system may localize the resulting per-cell PPA changes via meta-heuristic algorithms and advanced charting programs. The system may retain an accumulated list of recipe insights contributing to positive PPA improvements (final recommendation). In an example, the system can disable (e.g., prune or discard) the outliers in the design recipe and re-evaluate chip performance.

The system can perform iterative co-optimization between technology process and design. For example, it can use the method 500 flows successively and iteratively as a meta flow. In some examples, the dimensional reduction 506, clustering 508, outlier detection and classification 510, PPA design recipe identification 512, design recipe application 514, and optimization 516 may all be iterated. As shown in FIG. 5, the system may iterate method 500 any number of times, for example for a predetermined number of iterations or until reaching a threshold accuracy level. The meta flow can construct, for each unique design block, the best selection of technology library cells to achieve the optimal chip performance, power and area, as a multi-objective optimization. Such a multi-objective formulation can be re-defined or adjusted by users to enable further PPA trade-offs. In some examples, the best (e.g., highly or highest ranked) selection of technology library cells may be selected based on a ranking determined by the multi-objective optimization and/or by the hierarchical AI model.

This hierarchical design methodology may enable successive applications of the discovered PPA recipes to improve whole-chip PPA. For example, heterogenous tiles such as GPUs may benefit most from unique PPA recipes per sub-cluster. Compared with an average “best” recipe across the chip used by some PPA improvement approaches, the hierarchical approach of the method 500 may provide finer-grained and better overall PPA improvements.

The method 500 can then end.

FIG. 6 is a communication flow diagram illustrating a method 600 of iterative dimension reduction for insights derivation, according to an embodiment. In some examples, the method 600 can be performed by a computer system or other electronic device such as the electronic device 801 of FIG. 8.

Referring to FIG. 6, the method 600 can begin with the system obtaining oversized-dimensionality data 602. For example, the system can define key metrics as indicators of the PPA per design block (e.g., PPA features), as described in operation 502 of method 500 in the example of FIG. 5. In some examples, at least some of the PPA features may be obtained from DTCO.

The system can then send at 614 the oversized-dimensionality data 602 to the VAE engine 612. The VAE engine 612 can initialize the auto-encoder core, fine-tune trainable parameters, train and fit the VAE model, and compute errors associated with training and inference.

The VAE engine 612 can then output at 616 oversized-dimensionality data 602.

Next, the system may apply data engineering to refine the PPA features of oversized-dimensionality data 602, as described in operation 504 of method 500 in the example of FIG. 5. Accordingly, the system may convert at 618 oversized-dimensionality data 602 to high-dimensionality data 604, which may have moderately lower dimensionality than oversized-dimensionality data 602.

The system may then iterate the steps of reducing the dimensionality of the PPA features. For example, the system can send at 620 the high-dimensionality data 604 to the VAE engine 612. The VAE engine 612 can initialize the auto-encoder core, fine-tune trainable parameters, train and fit the VAE model, and compute errors associated with training and inference.

The VAE engine 612 can then output at 622 high-dimensionality data 604.

The system may apply data engineering to refine the PPA features of high-dimensionality data 604. Accordingly, the system may convert at 624 high-dimensionality data 604 to medium-dimensionality data 606, which may have lower dimensionality than high-dimensionality data 604.

Next, the system can send at 626 the medium-dimensionality data 606 to the VAE engine 612. The VAE engine 612 can initialize the auto-encoder core, fine-tune trainable parameters, train and fit the VAE model, and compute errors associated with training and inference.

The VAE engine 612 can then output at 628 medium-dimensionality data 606.

The system may apply data engineering to refine the PPA features of high-dimensionality data 604. Accordingly, the system may convert at 630 medium-dimensionality data 606 to low-dimensionality data 608.

Next, the system may apply data engineering to refine the PPA features of low-dimensionality data 608. Accordingly, the system may convert at 632 low-dimensionality data 608 to compact-dimensionality data 610. For example, the compact-dimensionality data 610 may have reduced dimensionality, such as in a latent space, as described above in the examples of FIGS. 1-3.

The iterative dimension reduction method 600 for insights derivation can then end.

FIG. 7 is a communication flow diagram illustrating a method 700 of outlier insights derivation, according to an embodiment. In some examples, the method 700 can be performed by a computer system or other electronic device such as the electronic device 801 of FIG. 8.

Referring to FIG. 7, the method 700 can begin with the system obtaining data 702. For example, the data 702 may be the compact-dimensionality data 610 output by VAE engine 612 in the example of FIG. 6. The system may perform preliminary proximity clustering for iso-performance power (e.g., PPA) optimization.

The system can then send at 714 the data 702 to the ML hyper clustering engine 712. The ML hyper clustering engine 712 can initialize multiple clustering engines, optimize a set of clusters, and evaluate error metrics for the optimized clusters. In some examples, the ML hyper clustering engine 712 may detect design elements with high PPA divergence within each cluster (e.g., outliers). In some examples, the system may classify outliers into categories of performance outliers, power leakage outliers, or area outliers. Alternatively or additionally, the system may perform outlier detection and classification at the end of method 700, e.g., while deriving outlier insights based on the optimal clustering data 710.

The ML hyper clustering engine 712 can then output at 716 the data 702.

Next, the system may convert at 718 the data 702 to large clustering error data 704, which may have a large clustering error.

The system may then iterate the steps of clustering the PPA features. For example, the system can send at 720 the large clustering error data 704 to the ML hyper clustering engine 712. The ML hyper clustering engine 712 can initialize multiple clustering engines, optimize a set of clusters, and evaluate error metrics for the optimized clusters. In some examples, ML hyper clustering engine 712 may detect design elements with high PPA divergence within each cluster (e.g., outliers). In some examples, the system may classify outliers into categories of performance outliers, power leakage outliers, or area outliers. Alternatively or additionally, the system may perform outlier detection and classification at the end of method 700, e.g., while deriving outlier insights based on the optimal clustering data 710.

The ML hyper clustering engine 712 can then output at 722 large clustering error data 704.

Next, the system may convert at 724 the large clustering error data 704 to medium clustering error data 706, which may have a smaller clustering error than large clustering error data 704.

Next, the system can send at 726 the medium clustering error data 706 to the ML hyper clustering engine 712. The ML hyper clustering engine 712 can initialize multiple clustering engines, optimize a set of clusters, and evaluate error metrics for the optimized clusters. In some examples, the ML hyper clustering engine 712 may detect design elements with high PPA divergence within each cluster (e.g., outliers). In some examples, the system may classify outliers into categories of performance outliers, power leakage outliers, or area outliers. Alternatively or additionally, the system may perform outlier detection and classification at the end of method 700, e.g., while deriving outlier insights based on the optimal clustering data 710.

The ML hyper clustering engine 712 can then output at 728 medium clustering error data 706.

The system may convert at 730 the medium clustering error data 706 to low clustering error data 708, which may have a smaller clustering error than medium clustering error data 706.

Next, the system may convert at 732 the low clustering error data 708 to optimal clustering data 710. For example, the optimal clustering data 710 may have an optimal level of clustering error.

In some examples, the ML hyper clustering engine 712 may detect design elements with high PPA divergence within each cluster (e.g., outliers). The system may derive outlier insights based on the optimal clustering data 710. For example, the system may classify outliers into categories of performance outliers, power leakage outliers, or area outliers. In another example, the system can disable outliers in the design recipe and re-evaluate the semiconductor chip design performance.

The outlier insights derivation method 700 can then end.

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single IC. For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a GPU, an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high- definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management IC (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH^{TM}, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of improving power/performance/area (PPA) of a semiconductor chip design, comprising:
refining a set of PPA features of the semiconductor chip design;
reducing a dimensionality of the set of PPA features by applying a variational autoencoder (VAE) or clustering;
selecting, for a respective design block within the semiconductor chip design, a respective highly ranked design element from a library of technology design elements, based on the reduced dimensionality;
applying the respective highly ranked design element to the respective design block within the semiconductor chip design to obtain an updated semiconductor chip design with improved PPA; and
outputting the updated semiconductor chip design for a semiconductor chip with improved PPA.

2. The method of claim 1, wherein refining the set of PPA features of the semiconductor chip design comprises:
defining the set of PPA features; and
applying data engineering to refine the set of PPA features.

3. The method of claim 1, wherein reducing the dimensionality of the set of PPA features comprises applying the VAE to construct a latent space.

4. The method of claim 1, wherein reducing the dimensionality of the set of PPA features comprises performing the clustering in a latent space, and performing the clustering comprises detecting outlier design elements in the latent space.

5. The method of claim 4, wherein performing the clustering further comprises classifying, in the reduced dimensionality and based on one or more key performance indicators (KPIs) for PPA, a respective outlier design element as a performance, power leakage, or area outlier design element.

6. The method of claim 1, wherein selecting the respective highly ranked design element is based on a hierarchical artificial intelligence (AI) model, and wherein applying the respective highly ranked design element is based on the hierarchical AI model.

7. The method of claim 6, further comprising identifying, based on the reduced dimensionality and the hierarchical AI model, one or more PPA design recipe for the semiconductor chip design, wherein the one or more PPA design recipe includes the respective highly ranked technology design element for the respective design block.

8. The method of claim 7, further comprising iteratively:
identifying, based on the reduced dimensionality and the hierarchical AI model, a second one or more PPA design recipe including a second respective highly ranked design element from the library of technology design elements for a second design block; and
applying the second respective highly ranked design element to the second design block;
within a multi-objective optimization of the PPA of the semiconductor chip design.

9. The method of claim 1, wherein selecting the respective highly ranked design element based on the reduced dimensionality comprises optimizing in the reduced dimensionality.

10. The method of claim 1, wherein at least some PPA features of the set of PPA features are obtained from design technology co-optimization (DTCO).

11. The method of claim 1, wherein the respective highly ranked design element from the library of technology design elements comprises a respective highly ranked cell, a respective highly ranked routing metal layer, a respective highly ranked interconnect topology, or another respective highly ranked interconnect.

12. A computer system configured to improve power/performance/area (PPA) of a semiconductor chip design, the computer system comprising:
at least one processor; and
memory that stores instructions, which when executed by the at least one processor, control the computer system to:
refine a set of PPA features of the semiconductor chip design;
reduce a dimensionality of the set of PPA features by applying a variational autoencoder (VAE) or clustering;
select, for a respective design block within the semiconductor chip design, a respective highly ranked design element from a library of technology design elements, based on the reduced dimensionality;
apply the respective highly ranked design element to the respective design block within the semiconductor chip design to obtain an updated semiconductor chip design with improved PPA; and
outputting the updated semiconductor chip design for a semiconductor chip with improved PPA.

13. The computer system of claim 12, wherein to refine the set of PPA features of the semiconductor chip design comprises:
to define the set of PPA features; and
to apply data engineering to refine the set of PPA features.

14. The computer system of claim 12, wherein to reduce the dimensionality of the set of PPA features comprises to apply the VAE to construct a latent space.

15. The computer system of claim 12, wherein to reduce the dimensionality of the set of PPA features comprises to perform the clustering in a latent space, and to perform the clustering comprises to detect outlier design elements in the latent space.

16. The computer system of claim 15, wherein to perform the clustering further comprises to classify, in the reduced dimensionality and based on one or more key performance indicators (KPIs) for PPA, a respective outlier design element as a performance, power leakage, or area outlier design element.

17. The computer system of claim 12, wherein to select the respective highly ranked design element is based on a hierarchical artificial intelligence (AI) model, and wherein to apply the respective highly ranked design element is based on the hierarchical AI model.

18. The computer system of claim 17, wherein the instructions further control the computer system to identify, based on the reduced dimensionality and the hierarchical AI model, one or more PPA design recipe for the semiconductor chip design, and wherein the one or more PPA design recipe includes the respective highly ranked design element for the respective design block.

19. The computer system of claim 18, wherein the instructions further control the computer system to iteratively:
identify, based on the reduced dimensionality and the hierarchical AI model, a second one or more PPA design recipe including a second respective highly ranked design element from the library of technology design elements for a second design block; and
apply the second respective highly ranked design element to the second design block;
within a multi-objective optimization of the PPA of the semiconductor chip design.

20. The computer system of claim 12, wherein:
to select the respective highly ranked design element based on the reduced dimensionality comprises to optimize in the reduced dimensionality; and
the respective highly ranked design element from the library of technology design elements comprises a respective highly ranked cell, a respective highly ranked routing metal layer, a respective highly ranked interconnect topology, or another respective highly ranked interconnect.
